(19) United States
(12) Patent Application Publication
(10) Pub. No.: US 2024/0090391 A1
(43) Pub. Date: Mar. 21, 2024

(54) Hose Irrigation Device

(71) Applicant: Bret Weaver, Moville, IA (US)

(72) Inventor: Bret Weaver, Moville, IA (US)

(21) Appl. No.: 17/946,103

(22) Filed: Sep. 16, 2022

(51) Int. Cl. A01G 25/02; F16B 25/00

(52) U.S. Cl. CPC A01G 25/023; A01G 25/026; F16B 25/0078

(57) ABSTRACT

A hose irrigation device for converting a conventional garden hose to an irrigation hose having adjustable flow rates includes a screw having a shaft and a head. The shaft is threaded for being inserted into a garden hose. The shaft may be inserted an adjustable depth into the garden hose. A channel extends into the shaft of the screw. The channel has a base end corresponding to a distal end of the shaft relative to the head. The base end is positionable within an interior of the garden hose. The channel has a top end positionable outside of the garden hose when the screw is inserted into the garden hose. Thus, fluid passing through the garden hose is expelled from the garden hose through the channel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to irrigation device and more particularly pertains to a new irrigation device for converting a conventional garden hose to an irrigation hose having adjustable flow rates.

### (2) Description of Related Art Including Information Disclosed Under 37 CFR 1.97 and 1.98

The prior art relates to irrigation device. Known prior art lacks adjustable flow rates and customizable irrigation points using a conventional garden hose.

### BRIEF SUMMARY OF THE INVENTION

An embodiment of the disclosure meets the needs presented above by generally comprising a screw having a shaft and a head. The shaft is threaded for being inserted into a garden hose. The shaft may be inserted an adjustable depth into the garden hose. A channel extends into the shaft of the screw. The channel has a base end corresponding to a distal end of the shaft relative to the head. The base end is positionable within an interior of the garden hose. The channel has a top end positionable outside of the garden hose when the screw is inserted into the garden hose. Thus, fluid passing through the garden hose is expelled from the garden hose through the channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom front side perspective view of a hose irrigation device according to an embodiment of the disclosure.

FIG. 2 is a front view of an embodiment of the disclosure.

FIG. 3 is a side view of an embodiment of the disclosure.

FIG. 4 is a top front side perspective view of an embodiment of the disclosure in use.

FIG. 5 is a cross-sectional view of an embodiment of the disclosure taken along line 4-4 of FIG. 4.

FIG. 6 is a cross-sectional view of an embodiment of the disclosure taken along line 6-6 of FIG. 5.

FIG. 7 is a front view of an alternate embodiment of the disclosure.

FIG. 8 is a front view of an alternate embodiment of the disclosure.

FIG. 9 is a front view of an alternate embodiment of the disclosure.

FIG. 10 is a partial cut-away front view of an alternate embodiment of the disclosure in use.

FIG. 11 is a front view of an alternate embodiment of the disclosure.

FIG. 12 is a front view of an alternate embodiment of the disclosure.

FIG. 13 is a cross-sectional view of an alternate embodiment of the disclosure similar to FIG. 5.

FIG. 14 is a front bottom perspective view of alternative distribution disks of an embodiment of the disclosure.

### DETAILED DESCRIPTION OF THE INVENTION

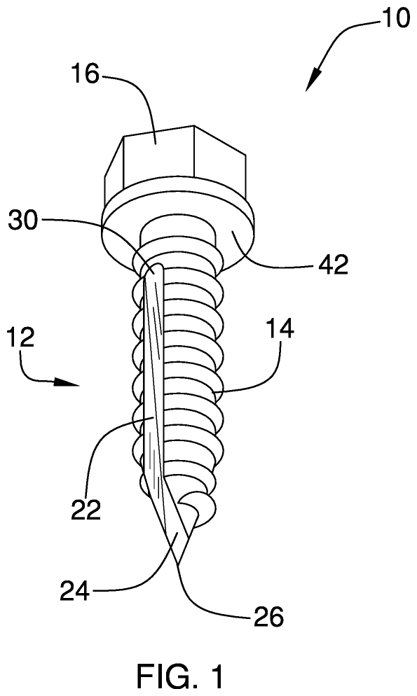

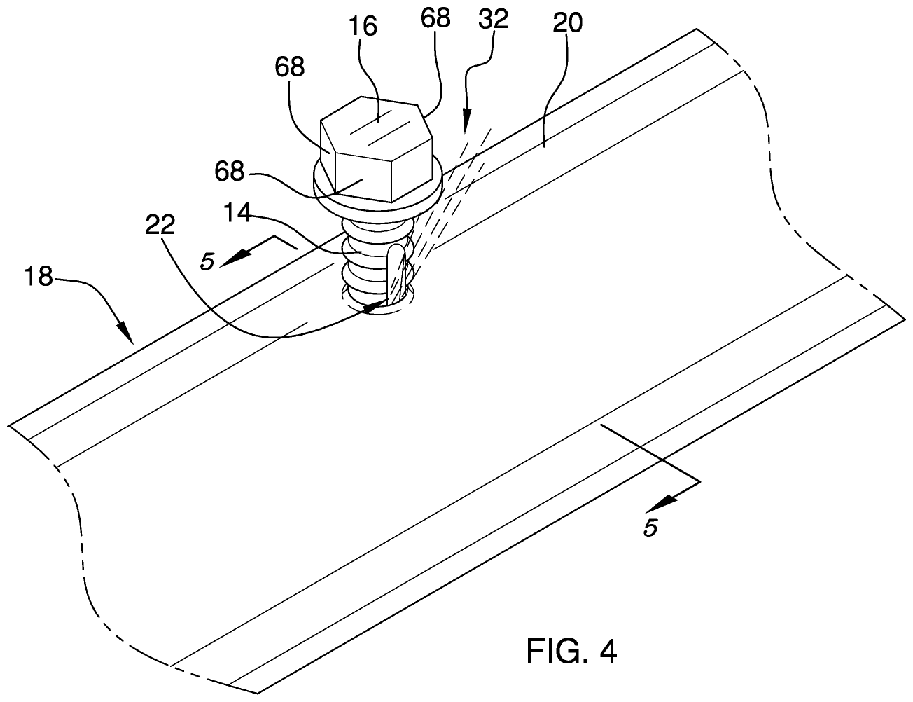

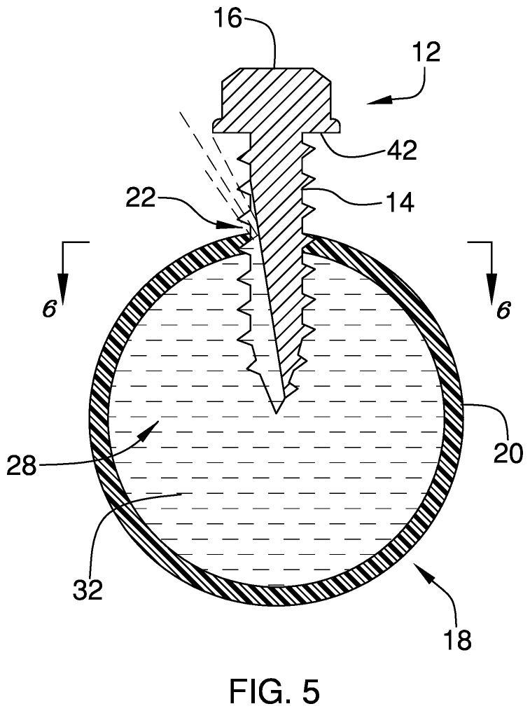

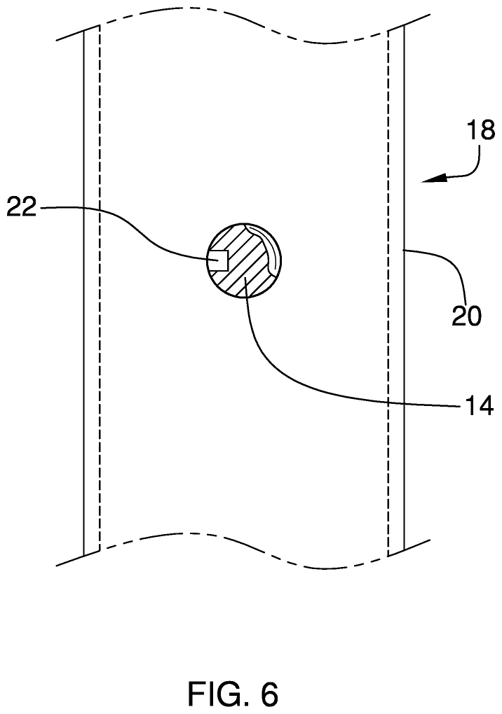

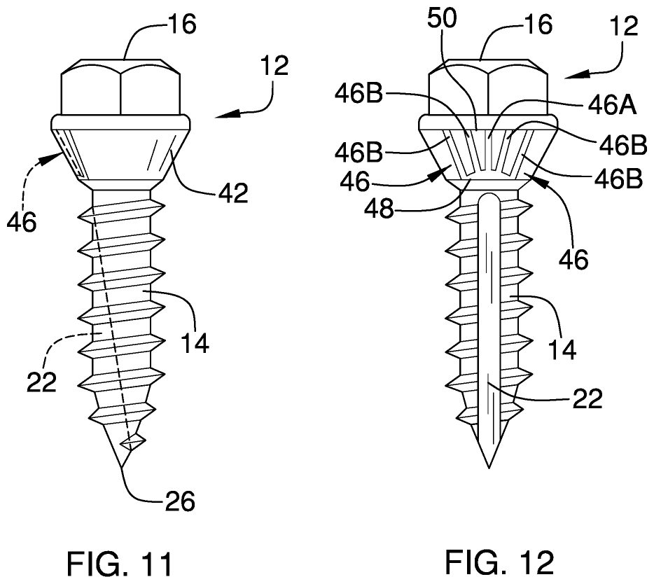

With reference now to the drawings, and in particular to FIGS. 1 through 14 thereof, a new irrigation device embodying the principles and concepts of an embodiment of the disclosure and generally designated by the reference numeral 10 will be described.

As best illustrated in FIGS. 1 through 14 the hose irrigation device 10 generally comprises a screw 12 having a shaft 14 and a head 16. The shaft 14 is threaded wherein the screw 12 is configured for being inserted into a garden hose 18. The garden hose 18 may be of conventional construction typically having an outer wall 20 of vinyl, rubber, or polyurethane such that the outer wall 20 will form a seal against the shaft 14 when the screw 12 is inserted into the garden hose 18 through the outer wall 20. The head 16 is rotatable wherein the shaft 14 is configured for being inserted an adjustable depth into the garden hose 18. The head 16 of the screw 12 has a plurality of outwardly facing facets 68 wherein the head 16 is configured for being engaged by a driving tool such as a wrench or the like. A channel 22 extends into the shaft 14 of the screw 12. The channel 22 has a base end 24 corresponding to a distal end 26 of the shaft 14 relative to the head 16. Thus, the base end 24 of the channel 22 is configured to be positioned within an interior 28 of the garden hose 18. The channel 22 has a top end 30 wherein the top end 30 is configured for being positioned outside of the garden hose 18 when the screw 12 is inserted into the garden hose 18 whereby fluid 32 passing through the garden hose 18 is expelled from the garden hose 18 through the channel 22. The channel 22 is tapered extending from the base end 24 to the top end 30 such that a depth of the channel 22 decreases approaching the top end 30 from the base end 24. The top end 30 of the channel 22 is spaced from the head 16 of the screw 12 wherein the channel 22 is configured for being positioned fully within the garden hose 18 such that the screw 12 is configured for inhibiting the fluid 32 passing through the garden hose 18 from being expelled from the garden hose 18 when the screw 12 is fully inserted into the garden hose 18.

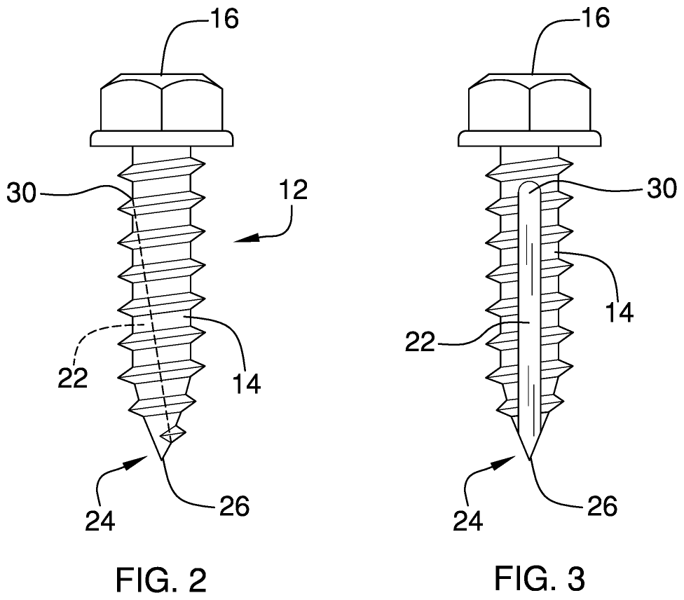

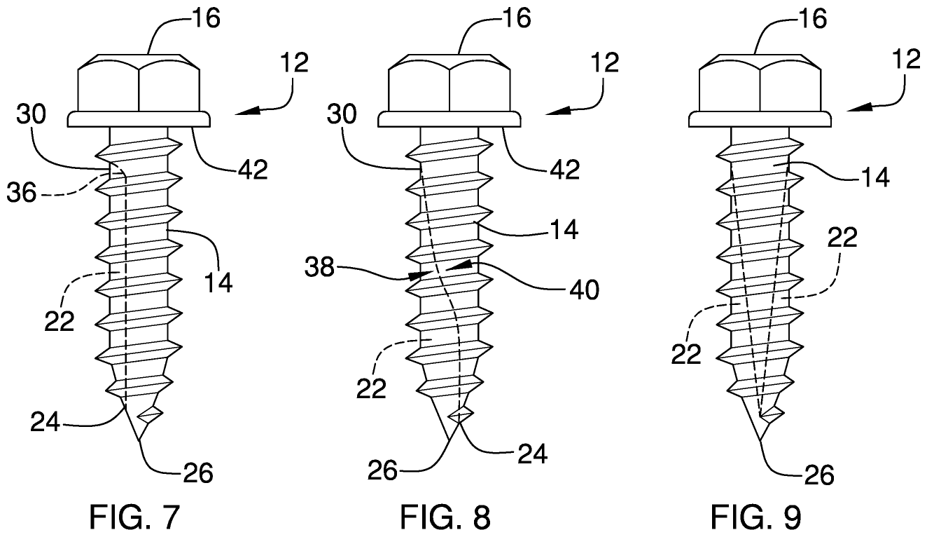

As shown in FIG. 2, the depth of the channel 22 decreases at a constant rate between the base end 24 and the top end 30. Alternatively, as shown in FIG. 7, the depth of the channel 22 is constant extending away from the base end 24 towards the top end 30 with the channel 22 having a curved bottom surface 36 adjacent to the top end 30 of the channel 22. Alternatively, as shown in FIG. 8, the depth of the channel 22 is constant extending away from the base end 24 of the channel 22 towards the top end 30 with the bottom of the channel 22 having a medial double curvature 38 wherein the depth of the channel lessens more sharply in a middle portion 40 of the channel 22 and lessens less sharply from the middle portion 40 of the channel to the top end 30. Another variation includes the incorporation of multiple channels 22 in the shaft 12 as shown in FIG. 9.

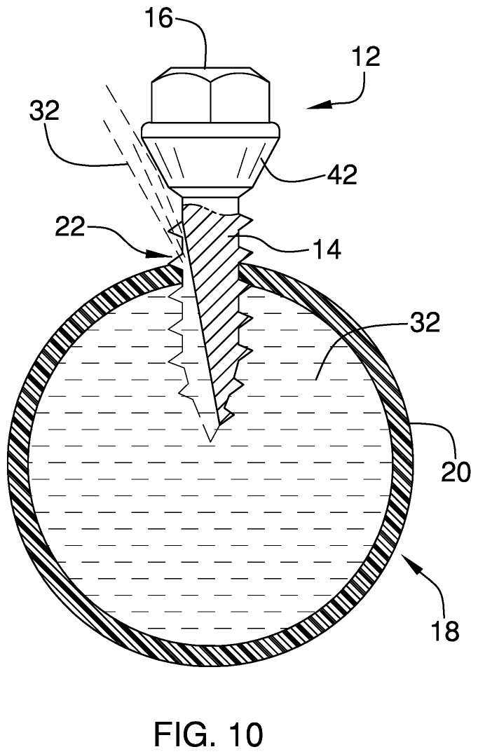

The head 16 of the screw 12 has a bottom surface 42 extending outwardly from the shaft 14. The channel 22 is positioned such that the channel 22 is configured to direct the fluid 32 expelled from the garden hose 18 into the bottom surface 42 wherein the bottom surface 42 is configured to direct the fluid 32 away from the screw 12. The shape of the bottom surface 42 may be altered or shaped to direct the fluid 32 in a desired direction or pattern. The bottom surface 42 may be perpendicular to a longitudinal axis of the shaft 14 as shown in FIGS. 1 through 9. Alternatively, as shown in FIGS. 10 through 12, the bottom surface 42 is conical such that the bottom surface 42 flares outwardly extending away from the shaft 14. As shown in FIG. 12, the bottom surface 42 includes a plurality of furrows 46. The furrows 46 are spaced apart and extend between a bottom edge 48 of the bottom surface 42 and a top edge 50 of the bottom surface 42. The furrows 46 may include a central furrow 46A linearly aligned with the channel 22. The furrows 46 may further include a plurality of outer furrows 46B. Each of the outer furrows 46B is angled relative to the central furrow 46A wherein the plurality of furrows 46 is configured to facilitate dispersal of the fluid 32 away from the screw 12.

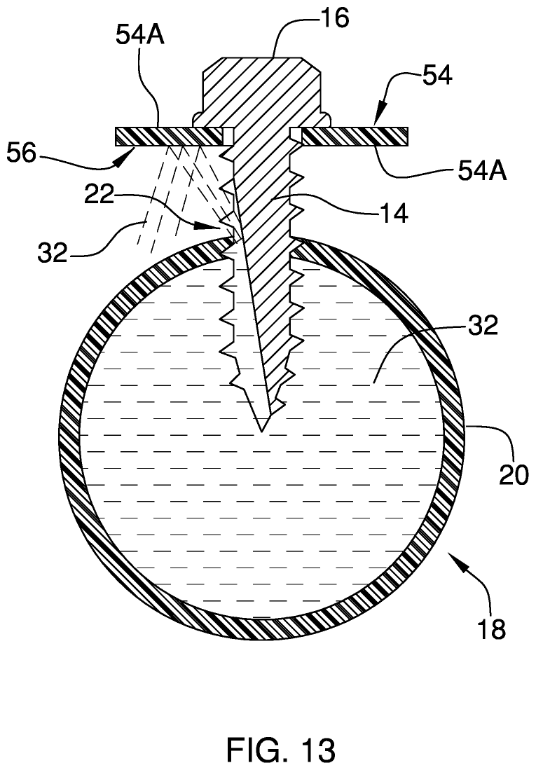

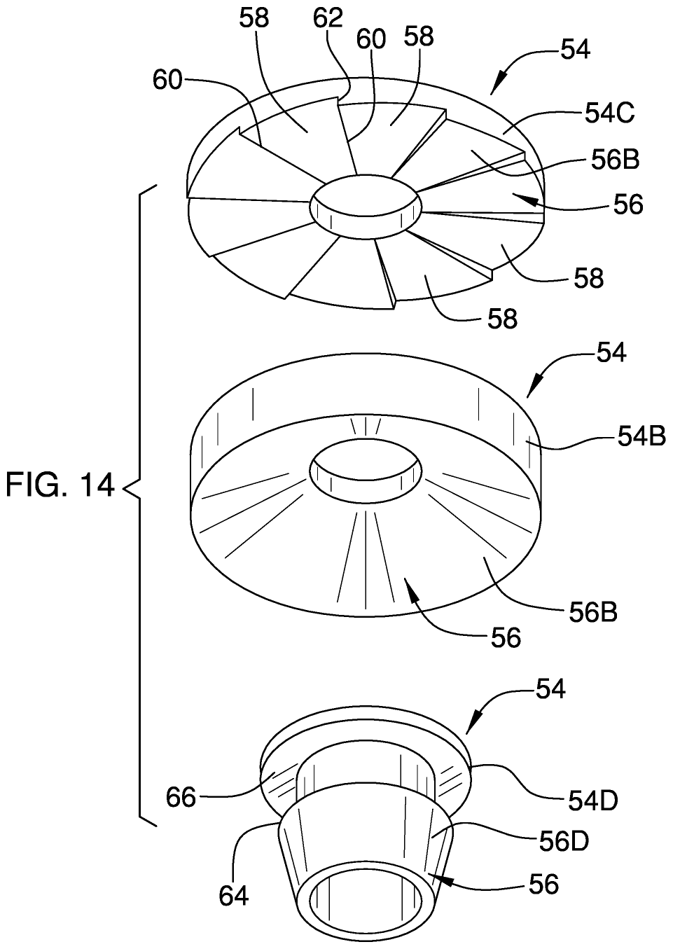

In an embodiment shown in FIG. 13, a distribution disk 54 is positionable on the shaft 14 adjacent to the head 16 of the screw 12. The distribution disk 54 has a distribution surface 56 facing the channel 22 when the distribution disk 54 is positioned on the shaft 14 adjacent to the head 16 of the screw 12. The distribution disk 54 may be one of a plurality of interchangeable distribution disks 54 having a respective distribution surface 56 to allow for customizable distribution characteristics of the fluid 32. In embodiments of the distribution disk 54A-D, 54A being shown in FIGS. 13 and 54B-D being shown collectively in FIG. 14, the distribution surface 56A is planar and the distribution surface 56A has a diameter greater than a diameter of the bottom surface 42 of the head 16 of the screw 12. Alternatively, the distribution surface 56B may be concave. In another alternative, the distribution surface 56C may have a plurality of sectors 58. The sectors 58 are radially arranged around the shaft 14. Each sector 58 has a raised edge 60 relative to an adjacently positioned one of the sectors 58 and an inset edge 62 relative to another adjacently positioned one of the sectors 58. In yet another alternative embodiment, the distribution surface 56D flares outwardly extending away from the shaft 14. The distribution surface 56D further has an upper edge spaced from a top flange 66 extending perpendicularly relative to a longitudinal axis of the shaft 14.

In use, the screw 12 is inserted into and through the outer wall 20 of the garden hose 18 creating a hole in the outer wall 20. The shaft 14 of the screw 12 substantially occupies the hole generally obstructing the fluid 32 from escaping through the hole. The fluid 32 is allowed to escape through the channel 22. The shape of the channel 22 may be varied as described above, and using any other shape or configuration, to disperse the fluid 32 in a desired direction or pattern. Further any dispersal pattern or direction may be controlled by the shape of the bottom surface 42 of the head 16 of the screw 12 as described above. To provide customization as an alternative to the bottom surface 42, the distribution disk 54A-D may be selected and used with the screw 12.

It is further contemplated that each of the alternative elements described above, and shown in at least one of the drawing figures, would be understood in view of the disclosure such that they may be combined in various configurations except where the structures would be mutually exclusive. For example, though not explicitly shown, the furrows shown in FIG. 12 may be incorporated into the structure as shown on distribution disk 54D in FIG. 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hose irrigation device comprising:
a screw having a shaft and a head, said shaft being threaded wherein said screw is configured for being inserted into a garden hose, said head being rotatable wherein said shaft is configured for being inserted an adjustable depth into the garden hose; and
a channel extending into said shaft of said screw, said channel having a base end corresponding to a distal end of said shaft relative to said head wherein said base end of said channel is configured being positioned within an interior of the garden hose, said channel having a top end wherein said top end is configured for being positioned outside of said garden hose when said screw is inserted into the garden hose whereby fluid passing through the garden hose is expelled from the garden hose through said channel.

2. The hose irrigation device of claim 1, further comprising said channel being tapered extending from said base end to said top end wherein a depth of said channel decreases approaching said top end from said base end.

3. The hose irrigation device of claim 1, further comprising said top end of said channel being spaced from said head of said screw wherein said channel is configured for being positioned fully within the garden hose such that the screw is configured for inhibiting the fluid passing through the garden hose from being expelled from the garden hose when said screw is fully inserted into the garden hose.

4. The hose irrigation device of claim 2, further comprising said depth of said channel decreasing at a constant rate between said base end and said top end.

5. The hose irrigation device of claim 2, further comprising said depth of said channel being constant extending away from said base end towards said top end, said channel having a curved bottom surface adjacent to said top end of said channel.

6. The hose irrigation device of claim 1, further comprising a depth of said channel being constant extending away from said base end of said channel towards said top end, a bottom of said channel having a medial double curvature wherein a depth of said channel lessens more sharply in a middle portion of said channel and lessens less sharply from said middle portion of said channel to said top end.

7. The hose irrigation device of claim 1, further comprising said head of said screw having a bottom surface extending outwardly from said shaft, said channel being positioned such that said channel is configured to direct the fluid expelled from the garden hose into said bottom surface wherein said bottom surface is configured to direct the fluid away from said screw.

8. The hose irrigation device of claim 7, further comprising said bottom surface being perpendicular to a longitudinal axis of said shaft.

9. The hose irrigation device of claim 7, further comprising said bottom surface being conical such that said bottom surface flares outwardly extending away from said shaft.

10. The hose irrigation device of claim 9, further comprising said bottom surface including a plurality of furrows, said furrows being spaced apart and extending between a bottom edge of said bottom surface and a top edge of said bottom surface.

11. The hose irrigation device of claim 10, further comprising said furrows including a central furrow linearly aligned with said channel.

12. The hose irrigation device of claim 11, further comprising said furrows including a plurality of outer furrows, each of said outer furrows being angled relative to said central furrow wherein said plurality of furrows are configured to facilitate dispersal of the fluid away from the screw.

13. The hose irrigation device of claim 8, further comprising a distribution disk, said distribution disk being positionable on said shaft adjacent to said head of said screw, said distribution disk having a distribution surface facing said channel when said distribution disk is positioned on said shaft adjacent to said head of said screw.

14. The hose irrigation device of claim 13, further comprising said distribution surface being planar, said distribution surface having a diameter greater than a diameter of said bottom of said head.

15. The hose irrigation device of claim 13, further comprising said distribution surface being concave.

16. The hose irrigation device of claim 13, further comprising said distribution surface having a plurality of sectors, said sectors being radially arranged around said shaft, each sector having a raised edge relative to an adjacently positioned one of said sectors and an inset edge relative to another adjacently positioned one of said sectors.

17. The hose irrigation device of claim 13, further comprising said distribution surface flaring outwardly extending away from said shaft, said distribution surface having an upper edge spaced from a top flange extending perpendicularly relative to a longitudinal axis of said shaft.

18. The hose irrigation device of claim 1, further comprising said head of said screw having a plurality of outwardly facing facets wherein said head is configured for being engaged by a driving tool.
